(19) United States
(12) Patent Application Publication
(10) Pub. No.: US 2020/0402743 A1
(43) Pub. Date: Dec. 24, 2020

(54) KEYBOARD DEVICE AND ASSEMBLY METHOD THEREOF

(71) Applicant: Primax Electronics Ltd., Taipei (TW)

(72) Inventor: Yi-Chen Wang, Taipei (TW)

(21) Appl. No.: 16/549,165

(22) Filed: Aug. 23, 2019

(30) Foreign Application Priority Data
Jun. 21, 2019 (TW) 108121779

(51) Int. Cl. H01H 13/7065; H01H 13/70; H01H 13/14

(52) U.S. Cl. CPC H01H 13/7065; H01H 2205/002; H01H 13/14; H01H 13/7006

(57) ABSTRACT

The present invention provides a keyboard device, including a plurality of key structures, where each key structure includes a thin-film circuit board, a key frame, an elastic element and a press assembly. The key frame is arranged on the thin-film circuit board, and includes a frame body and a bottom plate that are of an integrally formed structure. The bottom plate is located between the frame body and the thin-film circuit board, and has a through hole, and the thin-film circuit board covers the through hole. The elastic element is arranged on the thin-film circuit board, and a part of the elastic element is located in the through hole in the bottom plate. The press assembly is arranged in the key frame, and the elastic element is located between the press assembly and the thin-film circuit board. The present invention further provides a keyboard device assembly method.

### FIELD OF THE INVENTION

The present invention relates to the field of input devices, and in particular, to a keyboard device and an assembly method thereof.

### BACKGROUND OF THE INVENTION

With the progress of science and technology, the development of electronic apparatuses has brought great convenience to human life. Therefore, it is an important subject to provide electronic apparatuses with more user-friendly operations. Common input devices of an electronic apparatus include a mouse device, a keyboard device and a trackball device. Among them, the keyboard device allows a user to directly input text and symbols into a computer, and has gained much attention.

First, the structure and functions of a conventional keyboard device are described. FIG. 1 is a schematic structural diagram of appearance of the conventional keyboard device, FIG. 2 is a schematic cross-sectional view of a part of the structure of the keyboard device shown in FIG. 1, and FIG. 3 is a schematic exploded view of elements in the part of the structure of the keyboard device shown in FIG. 2. To make the illustration clearer, FIG. 2 and FIG. 3 only depict a part of a key frame, a single key structure and structures of related elements. Referring to FIG. 1 to FIG. 3, a conventional keyboard device 1 includes a plurality of key structures 10. Each key structure 10 includes a bottom plate 101, a thin-film circuit board 102, and a key frame 103, and the thin-film circuit board 102 has a thin-film switch 1021. Each key structure 10 further includes a keycap 104, a scissors-type connection element 105 and an elastic element 106. The scissors-type connection element 105 is connected between the keycap 104 and the bottom plate 101, and further includes a first frame 1051 and a second frame 1052 pivotally connected to the first frame 1051, so that the first frame 1051 and the second frame 1052 may turn relative to each other. In addition, the elastic element 106 is disposed between the keycap 104 and the bottom plate 101.

When the keycap 104 of any one of the key structure 10 is pressed and moves downward relative to the bottom plate 101, the first frame 1051 and the second frame 1052 of the scissors-type connection element 105 change from an extended state to a retracted state, and the keycap 104 that moves downward may be pressed against the elastic element 106 and enable an urging portion of the elastic element 106 to urge and trigger the corresponding thin-film switch 1021, so that the keyboard device 1 generates a corresponding key signal. When the keycap 104 of the key structure 10 is released, the keycap 104 moves upward relative to the bottom plate 101 in response to an elastic recovery force of the elastic element 106. At this time, the first frame 1051 and the second frame 1052 change from the retracted state to the extended state, and the keycap 104 returns to the original position.

However, in the conventional keyboard device 1, the thin-film circuit board 102, the keycap 104, the scissors-type connection element 105, and the elastic element 106 are carried on a carrier including the bottom plate 101 and the key frame 103. Therefore, to produce the bottom plate 101 and the key frame 103, it is necessary to fabricate separate molds for the two components, which greatly increases the production cost. In addition, the assembly process of the conventional keyboard device 1 is to first assemble the thin-film circuit board 102, the elastic element 106, the scissors-type connection element 105 and the keycap 104 onto the bottom plate 101 in sequence, and then to assemble the bottom plate 101 carrying the thin-film circuit board 102, the elastic element 106, the scissors-type connection element 105, and the keycap 104 with the key frame 103 by means of hot melting, buckling or locking. However, moisture can easily enter the keyboard device 1 assembled with the above process through an assembly joint of the bottom plate 101 and the key frame 103, thereby causing damage to the thin-film circuit board 102. Therefore, it is a focus of persons skilled in the art to solve the above problem.

### SUMMARY OF THE INVENTION

An objective of the present invention is to provide a keyboard device and an assembly method thereof. The keyboard device has a key frame and a bottom plate that are of an integrally formed structure, and the assembly method is easy to implement, thereby effectively reducing the production cost.

Other objectives and advantages of the present invention may be further understood from technical features disclosed in the present invention.

To achieve one of, a part of or all of the above objectives, or other objectives, the present invention provides a keyboard device, including a plurality of key structures, where each key structure includes a thin-film circuit board, a key frame, an elastic element, and a press assembly. The key frame is arranged on the thin-film circuit board, and includes a frame body and a bottom plate that are of an integrally formed structure. The bottom plate is located between the frame body and the thin-film circuit board and has a through hole, and the thin-film circuit board covers the through hole. The elastic element is arranged on the thin-film circuit board, and a part of the elastic element is located in the through hole in the bottom plate. The press assembly is arranged in the key frame, and the elastic element is located between the press assembly and the thin-film circuit board.

In an embodiment of the present invention, the elastic element has a bottom surface facing the thin-film circuit board, where the bottom surface of the elastic element is connected to the thin-film circuit board, and an area of the bottom surface is smaller than an area of the through hole.

In an embodiment of the present invention, the elastic element has a bottom surface facing the thin-film circuit board, where the bottom surface of the elastic element is connected to the thin-film circuit board, and an area of the bottom surface is larger than an area of the through hole, so that the elastic element and the through hole are in a tight fit state.

In an embodiment of the present invention, the press assembly includes a keycap and a scissors-type connection element, where the scissors-type connection element is located between the bottom plate of the key frame and the keycap.

In an embodiment of the present invention, the bottom plate of the key frame has a first surface and a second surface opposite to each other, where a key is connected to the first surface of the bottom plate, and the thin-film circuit board is attached on the second surface of the bottom plate.

In an embodiment of the present invention, a material of the key frame includes plastics.

The present invention further provides a keyboard device assembly method, which is applicable to the keyboard device above. The keyboard device assembly method include the following steps: assembling the key onto the first surface of the bottom plate in a direction from above the key frame towards the key frame; assembling the elastic element onto the thin-film circuit board; and assembling the thin-film circuit board onto the second surface of the bottom plate in a direction from below the key frame towards the key frame, and passing the elastic element through the through hole in the bottom plate, so that a part of the elastic element is located in the through hole, where the second surface is opposite to the first surface.

In an embodiment of the present invention, the key includes a keycap and a scissors-type connection element, and the step of assembling the key onto the first surface of the bottom plate includes: assembling the scissors-type connection element onto the first surface of the bottom plate in the direction from above the key frame towards the key frame; and assembling the keycap to the scissors-type connection element, so that the scissors-type connection element is located between the keycap and the bottom plate.

Each key structure of the keyboard device of this embodiment of the present invention has the key frame composed of the frame body and the bottom plate that are of an integrally formed structure, so that the key frame needs only one mold and can be produced in one step or by means of multi-shot injection molding, thereby effectively reducing the production cost of the keyboard. Moreover, because the key frame is of an integrally formed structure, no assembly joint exists between the bottom plate and the frame body, so that it is not easy for moisture to enter the keyboard device to cause damage to the thin-film circuit board, thereby effectively prolonging the service life of the keyboard device. In addition, on the condition that the key frame is of an integrally formed structure, in the keyboard device assembly process, the keycap and the scissors-type connection element are assembled from above the key frame, and the thin-film circuit board and the elastic element are assembled from below the key frame. In this way, the assembly process is simplified and requires fewer holes in the structure, thereby greatly improving waterproof and weather-resistant effects.

In order to make the above and other objectives, features, and advantages of the present invention more obvious and easier to understand, preferred embodiments are described in detail below with reference to the accompanying drawings.

### BRIEF DESCRIPTION OF THE DRAWINGS

FIG. 1 is a schematic structural diagram of appearance of a conventional keyboard device;

FIG. 2 is a schematic cross-sectional view of a part of the structure of the keyboard device shown in FIG. 1;

FIG. 3 is a schematic exploded view of elements in the part of the structure of the keyboard device shown in FIG. 2;

FIG. 4 is a schematic structural diagram of appearance of a keyboard device according to an embodiment of the present invention;

FIG. 5 is a schematic cross-sectional view of a part of the structure of the keyboard device shown in FIG. 4;

FIG. 6 is a schematic exploded view of elements in the part of the structure of the keyboard device shown in FIG. 5;

FIG. 7A to FIG. 7D are schematic diagrams of an assembly process of the keyboard device shown in FIG. 5 and FIG. 6; and

FIG. 8 is a schematic cross-sectional view of a part of the structure of a keyboard device according to another embodiment of the present invention.

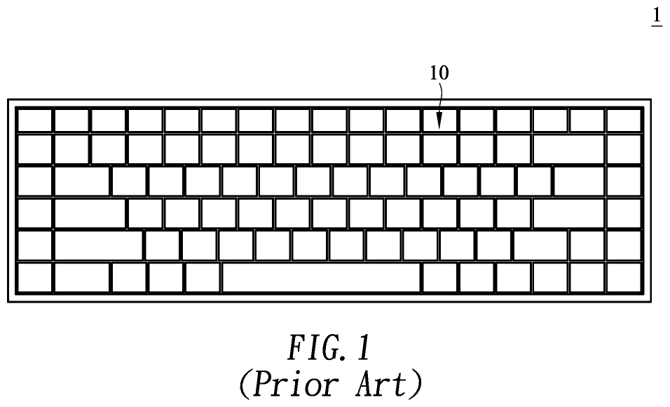

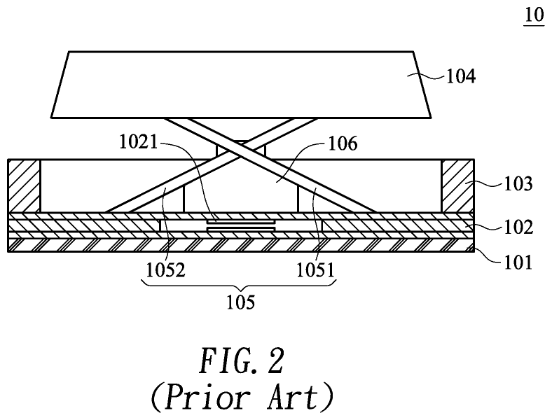

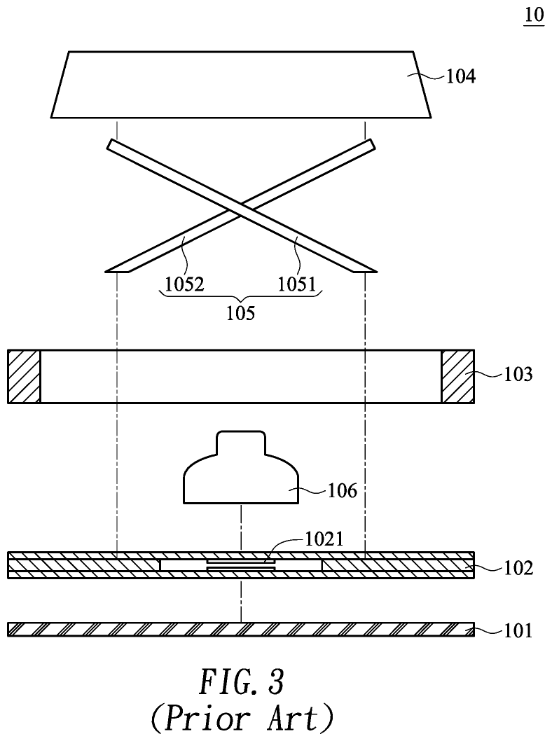

### DETAILED DESCRIPTION OF THE PREFERRED EMBODIMENT

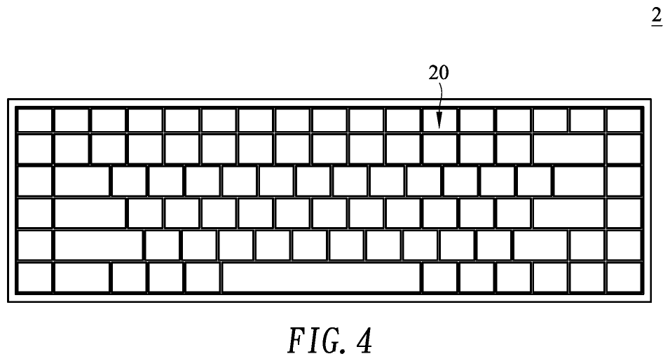

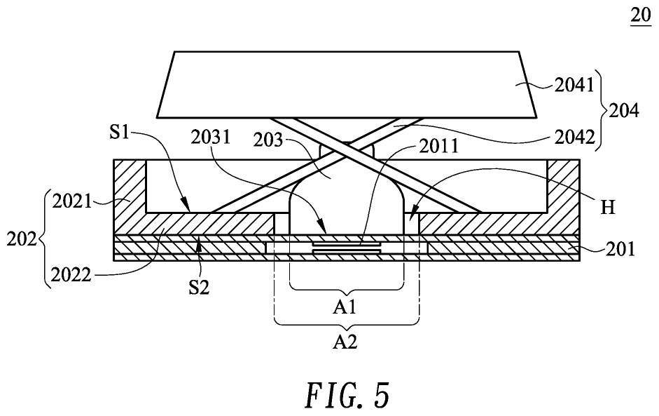

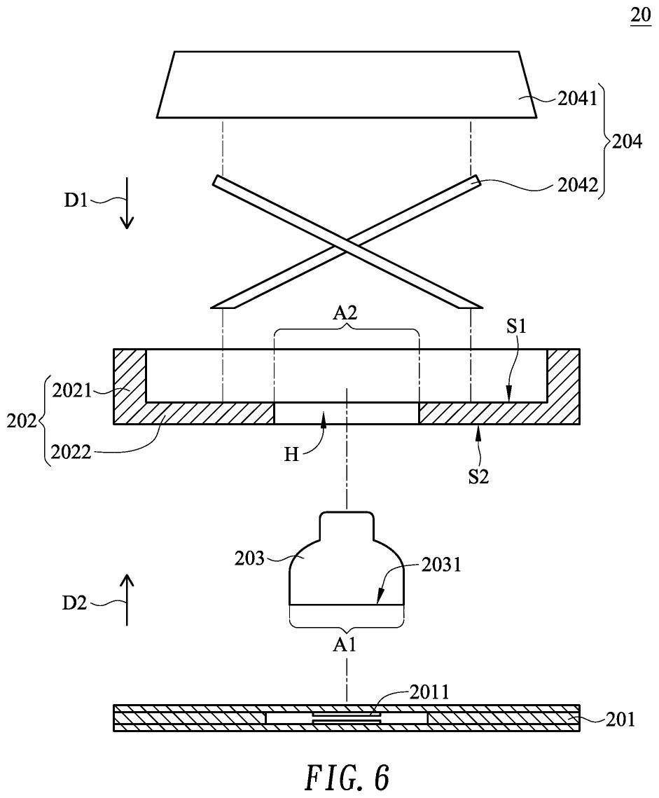

FIG. 4 is a schematic structural diagram of appearance of a keyboard device in an embodiment of the present invention. FIG. 5 is a schematic cross-sectional view of a part of the structure of the keyboard device shown in FIG. 4. FIG. 6 is a schematic exploded view of elements in the part of the structure of the keyboard device shown in FIG. 5. To make the illustration clearer, FIG. 5 and FIG. 6 only show a single key and related elements. Referring to FIG. 4 to FIG. 6, as shown in FIG. 4, a keyboard device 2 includes a plurality of key structures 20, the key structures 20 may be classified into general keys, number keys and function keys and the like, which may be separately pressed by a user with fingers to enable the keyboard device 2 to generate corresponding key signals to a computer, and then the computer performs corresponding functions. For example, general keys are used to input symbols such as English letters, number keys are used to input numbers, and function keys are used to provide various shortcut functions such as F1 to F12.

Other detailed structures of the keyboard device 2 of this embodiment of the present invention are further described below.

As shown in FIG. 5 and FIG. 6, each key structure 20 of the keyboard device 2 of this embodiment includes a thin-film circuit board 201, a key frame 202, an elastic element 203 and a press assembly 204. The thin-film circuit board 201 has a thin-film switch 2011. The key frame 202 is arranged on the thin-film circuit board 201, and includes a frame body 2021 and a bottom plate 2022 that are of an integrally formed structure. The bottom plate 2022 is located between the frame body 2021 and the thin-film circuit board 201, and has a through hole H. Specifically, the thin-film circuit board 201 covers a lower opening of the through hole H, and the thin-film switch 2011 of the thin-film circuit board 201 is located in the through hole H. The elastic element 203 is arranged on the thin-film circuit board 201, and a part of the elastic element 203 is located in the through hole H in the bottom plate 2022 and covers the thin-film switch 2011 that is also located in the through hole H. The press assembly 204 is arranged in the key frame 202, and the elastic element 203 is located between the press assembly 204 and the thin-film circuit board 201.

Referring further to FIG. 5 and FIG. 6, the press assembly 204 of this embodiment includes a keycap 2041 and a scissors-type connection element 2042. The scissors-type connection element 2042 is located between the key frame 202 and the keycap 2041. Specifically, the scissors-type connection element 2042 is arranged on the bottom plate 2022 of the key frame 202, and the scissors-type connection element 2042 and the bottom plate 2022 are connected, for example, by means of disposing a hook (not shown in the figure) on the bottom plate 2022 for the connection of the scissors-type connection element 2042. However, the present invention does not limit the connection manner between the scissors-type connection element 2042 and the bottom plate 2022, and different connection manners may be selected according to requirements of actual situations. The scissors-type connection element 2042 of this embodiment operates in the same way as the conventional technology, and details are not described in the present invention.

Referring again to FIG. 5 and FIG. 6, the bottom plate 2022 of the key frame 202 of this embodiment has a first surface S1 and a second surface S2 that are opposite to each other. The press assembly 204 is connected to the first surface of the bottom plate 2022, that is, the keycap 2041 is connected, by using the scissors-type connection element 2042, to the first surface S1 of the bottom plate 2022. The thin-film circuit board 201 is attached on the second surface S2 of the bottom plate 2022, and covers the lower opening of the through hole H, where the lower opening is located in the second surface S2. According to the above descriptions, the key frame 202 is formed by the frame body 2021 and the bottom plate 2022 that are of an integrally formed structure, so that an assembly process of each key structure 20 of the keyboard device 2 of this embodiment is obviously different from the assembly process of a conventional keyboard device: the keycap 2041 and the scissors-type connection element 2042 of this embodiment are assembled onto the first surface S1 of the bottom plate 2022 in a first direction D1 from above the key frame 202, the thin-film circuit board 201 is assembled onto the second surface S2 of the bottom plate 2022 in a second direction D2 from below the key frame 202, and the elastic element 203 arranged on the thin-film circuit board 201 may pass through the through hole H when the thin-film circuit board 201 is attached on the second surface S2 of the bottom plate 2022. The assembly process of the keyboard device 2 of this embodiment is described below.

In this embodiment, a material of the key frame 202 is, for example, plastics, that is, the frame body 2021 and the bottom plate 2022 use a plastics material and are of an integrally formed structure. However, the present invention does not limit the material of the key frame 202, and the material of the key frame 202 may be changed according to requirements of actual situations. An advantage of the key frame 202 made of the plastics material is that, the weight of each key structure 20 may be reduced, so that the overall weight of the keyboard device 2 is greatly reduced. In addition, the key frame 202 of this embodiment, for example, uses the frame body 2021 and the bottom plate 2022 that are integrally formed in one step or by means of multi-shot injection molding, but the present invention does not limit the production process of the key frame 202.

In this embodiment, the elastic element 203 has a bottom surface 2031 facing the thin-film circuit board 201, where the bottom surface 2031 of the elastic element 203 is connected to the thin-film circuit board 201, and an area A1 of the bottom surface 2031 of the elastic element 203 is smaller than an area A2 of the through hole H, so that the elastic element 203 can pass through the through hole H in the key frame 202 when the thin-film circuit board 201 is attached on the second surface S2 of the bottom plate 2022. It should be noted in particular that, the area A1 of the bottom surface 2031 of the elastic element 203 is larger than an area of any horizontal cross-section of the elastic element 203.

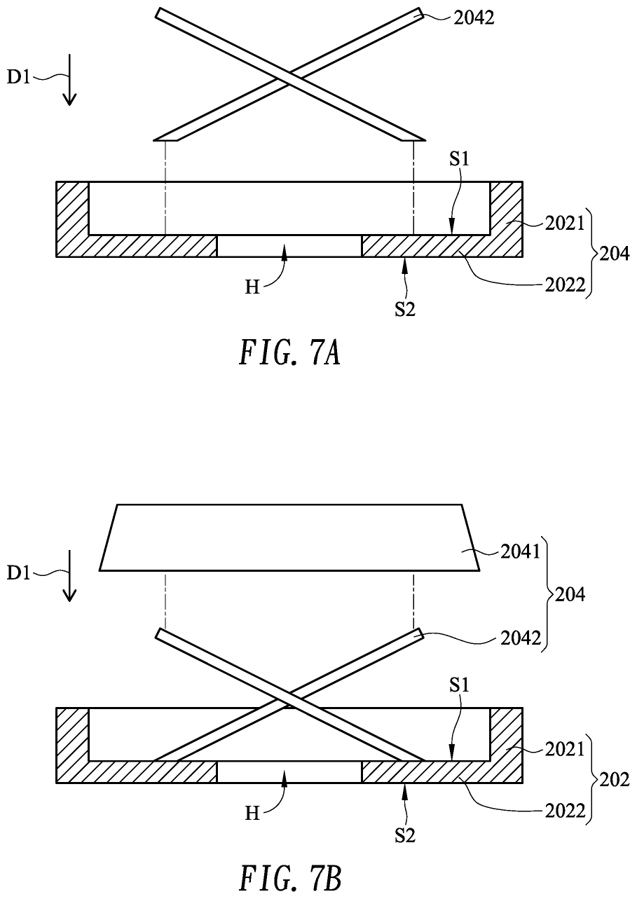

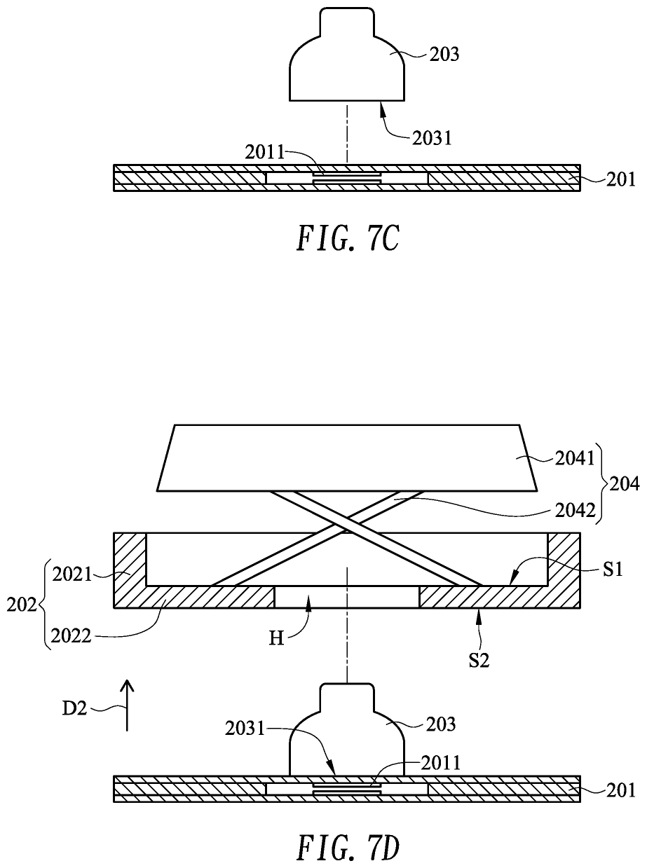

Referring to FIG. 7A to FIG. 7D, schematic diagrams of an assembly process of the keyboard device shown in FIG. 5 and FIG. 6 are depicted. The keyboard device assembly process of this embodiment includes the following steps: first, as shown in FIG. 7A, the scissors-type connection element 2042 is assembled onto the first surface S1 of the bottom plate 2022 in the first direction D1 (that is, in a direction towards the key frame 202) from above the key frame 202; then, as shown in FIG. 7B, the keycap 2041 is assembled to the scissors-type connection element 2042 in the first direction D1 from above the key frame 202, so that the scissors-type connection element 2042 is located between the keycap 2041 and the bottom plate 2022; then, as shown in FIG. 7C, the elastic element 203 is assembled onto the thin-film circuit board 201; and then, as shown in FIG. 7D, the thin-film circuit board 201 is assembled onto the second surface S2 of the bottom plate 2022 in the second direction D2 (that is, in a direction towards the key frame 202) from below the key frame 202, and at the same time, the elastic element 203 passes through the through hole H in the bottom plate 2022, so that a part of the elastic element 203 is located in the through hole H. It should be noted in particular that, in the steps in FIG. 7A and FIG. 7B in another order, that is, the keycap 2041 is assembled to the scissors-type connection element 2042 first, and then the scissors-type connection element 2042 is assembled onto the first surface S1 of the bottom plate 2022.

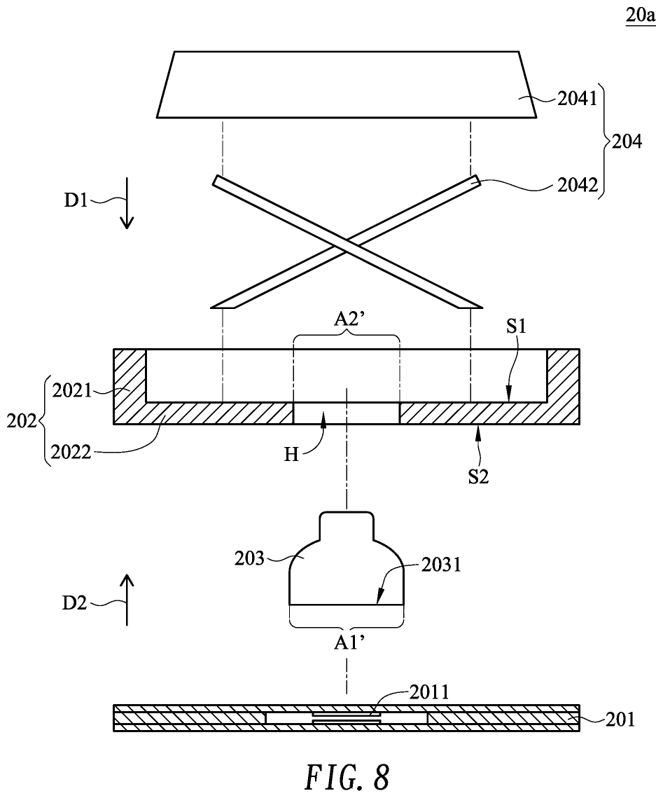

FIG. 8 is a schematic cross-sectional view of a part of the structure of a keyboard device according to another embodiment of the present invention. Referring to FIG. 8, a key structure 20a of this embodiment is similar to the key structure 20 shown in FIG. 4 to FIG. 6, and a difference lies in that, an area A1′ of a bottom surface 2031 of an elastic element 203 of this embodiment is larger than an area A2′ of a through hole H in a bottom plate 2022 of a key frame 202. When the elastic element 203 passes through the key frame 202 and a part of the elastic element 203 is located in the through hole H, because of an elastic recovery force of the elastic element 203, the elastic element 203 and the through hole H are in a tight fit state. As the elastic element 203 and the through hole H are in a tight fit state, almost no gap exists between the elastic element 203 and an inner wall of the through hole H. Therefore, under such a structural design, external moisture may be effectively prevented from entering the bottom of the key frame 202 and causing damage to the thin-film circuit board 201.

In conclusion, each key structure of the keyboard device of the embodiments of the present invention has the key frame composed of the frame body and the bottom plate that are of an integrally formed structure, so that the key frame needs only one mold and can be produced in one step or by means of multi-shot injection molding, thereby effectively reducing the production cost of the keyboard. Moreover, because the key frame is of an integrally formed structure, no assembly joint exists between the bottom plate and the frame body, so that it is not easy for moisture to enter the keyboard device to cause damage to the thin-film circuit board, thereby effectively prolonging the service life of the keyboard device. In addition, on the condition that the key frame is of an integrally formed structure, in the keyboard device assembly process, the keycap and the scissors-type connection element are assembled from above the key frame, and the thin-film circuit board and the elastic element are assembled from below the key frame. In this way, the assembly process is simplified and requires fewer holes in the structure, thereby greatly improving waterproof and weather-resistant effects.

The above descriptions are only preferred embodiments of the present invention, and an implementation scope of the present invention shall not be limited by the embodiments. All simple equivalent changes and modifications made in accordance with the claims and the specification of the present invention are still within the protection scope of the present invention. In addition, any one of the embodiments or the claims of the present invention need not to achieve all the objectives or advantages or features disclosed in the present invention. Moreover, the abstract and the title are used only to assist in the search of patent documents, and are not used to limit the scope of the present invention. In addition, the terms “first”, “second” and the like mentioned in the specification or in the claims are only used to name elements or to distinguish between different embodiments or scopes, and are not used to limit the upper or lower limit of a quantity of the elements.

What is claimed is:

1. A keyboard device, comprising:
a plurality of key structures, wherein each key structure comprises:
a thin-film circuit board;
a key frame, arranged on the thin-film circuit board, and comprising a frame body and a bottom plate that are of an integrally formed structure, wherein the bottom plate is located between the frame body and the thin-film circuit board and has a through hole, and the thin-film circuit board covers the through hole;
an elastic element, arranged on the thin-film circuit board, wherein a part of the elastic element is located in the through hole in the bottom plate; and
a press assembly, arranged in the key frame, wherein the elastic element is located between the press assembly and the thin-film circuit board.

2. The keyboard device according to claim 1, wherein the elastic element has a bottom surface facing the thin-film circuit board, the bottom surface of the elastic element is connected to the thin-film circuit board, and an area of the bottom surface is smaller than an area of the through hole.

3. The keyboard device according to claim 1, wherein the elastic element has a bottom surface facing the thin-film circuit board, the bottom surface of the elastic element is connected to the thin-film circuit board, and an area of the bottom surface is larger than an area of the through hole, so that the elastic element and the through hole are in a tight fit state.

4. The keyboard device according to claim 1, wherein the press assembly comprises a keycap and a scissors-type connection element, and the scissors-type connection element is located between the bottom plate of the key frame and the keycap.

5. The keyboard device according to claim 1, wherein the bottom plate of the key frame has a first surface and a second surface opposite to each other, the press assembly is connected to the first surface of the bottom plate, and the thin-film circuit board is attached on the second surface of the bottom plate.

6. The keyboard device according to claim 1, wherein a material of the key frame comprises plastics.

7. A keyboard device assembly method, applicable to the keyboard device according to claim 1, wherein the keyboard device assembly method comprises the following steps:
assembling the press assembly onto a first surface of the bottom plate in a direction from above the key frame towards the key frame;
assembling the elastic element onto the thin-film circuit board; and
assembling the thin-film circuit board onto a second surface of the bottom plate in a direction from below the key frame towards the key frame, and passing the elastic element through the through hole in the bottom plate, so that a part of the elastic element is located in the through hole, wherein the second surface is opposite to the first surface.

8. The keyboard device assembly method according to claim 7, wherein the press assembly comprises a keycap and a scissors-type connection element, and the step of assembling the press assembly onto the first surface of the bottom plate comprises:
assembling the scissors-type connection element onto the first surface of the bottom plate in a direction from above the key frame towards the key frame; and
assembling the keycap to the scissors-type connection element, so that the scissors-type connection element is located between the keycap and the bottom plate.
